(19) United States
(12) Patent Application Publication
(10) Pub. No.: US 2021/0013571 A1
(43) Pub. Date: Jan. 14, 2021

(54) COMPACT NON-RECIPROCAL CIRCUIT ELEMENT

(71) Applicant: 3RWAVE CO. LTD., Gyeonggi-do (KR)

(72) Inventors: Yong Ju BAN, Seoul (KR); Sun Hyuk KIM, Gyeonggi-do (KR)

(21) Appl. No.: 16/708,665

(22) Filed: Dec. 10, 2019

(30) Foreign Application Priority Data
Jul. 10, 2019 (KR) 10-2019-0083017

(51) Int. Cl. H01P 1/38; H01P 1/36

(52) U.S. Cl. CPC H01P 1/38; H01P 1/36

(57) ABSTRACT

The purpose of the present disclosure is to improve, in a design and configuring method of a non-reciprocal circuit element such as an isolator or a circulator, the design and configuring method so as to be suitable for miniaturization and mass production. Protrusions formed in a lower case of a device are assembled to openings formed in a cover case. Here, the cover case is aligned to be matched to the position of the protrusions of a lower case by means of a guide structure provided in the cover case, and the protrusions of the lower case and the openings of the cover case are assembled to each other.

### CROSS-REFERENCE TO RELATED APPLICATION

This application claims priority to Korean Patent Application No. 10-2019-0083017 filed on Jul. 10, 2019 and all the benefits accruing therefrom under 35 U.S.C. § 119, the contents of which are incorporated by reference in their entirety.

### BACKGROUND

The present disclosure relates to a high-frequency component, and more particularly, to an SMD-type non-reciprocal element.

Non-reciprocal circuit elements such as circulators and isolators are high-frequency communication components each generally designed such that a signal input through a predetermined port is rotated in one direction according to Faraday rotation and transmitted to another predetermined port.

The circulator commonly has three ports, and is designed such that the signal input from each port generally has the same transmission coefficient and the same reflection coefficient and is transmitted to another adjacent port. Accordingly, each port is an input port and may serve as an output port having directivity with respect to an adjacent port. FIG. 1 illustrates a general symbol for a circulator.

The isolator is designed such that a termination resistor is connected to one of the three ports and each port may serve only one function. That is, the signal input from an input port is transmitted through an output port, and conversely, the signal input from the output port is transmitted to a termination port connected with the terminal resistor and is destructed. Accordingly, in an ideal isolator, the signal input from an output port is not transmitted to an input port but is blocked.

In general, the isolator and the circulator are located between a power amplifier and an antenna in a transmission terminal of a wireless communication device and assist the signal amplified by the power amplifier to be transmitted to the antenna with a small loss, whereas the isolator and the circulator serve a function to block a signal reflected back from the antenna or an undesired signal to be transmitted to the power amplifier.

Due to the increasing demand for wireless communication and advance in communication technology, the demand for communication apparatus has been increased and price competition has become intense. Also in the case of non-reciprocal elements such as circulators and isolators, in order to reduce the manufacturing costs, a design for a structure having a small size and suitable for mass production has been actively carried out.

FIG. 2 is an exploded assembly view of a general surface mount-type circulator. A center conductor 141 and two microwave ferrites 145 and 146 which constitute a resonator are laminated and inserted in a housing 148 made of a soft magnetic material together with a permanent magnet 143 and pole pieces 144 and 147, and a lid 142 which is also made of a soft magnetic material presses and fixes the laminated and inserted internal elements. The center conductor 141 may include three connection leads 141a, 141b and 141c substantially having intervals of 120 degrees.

FIG. 3 is a side view of a general surface mount-type circulator. The connection leads 141a, 141b and 141c of the center conductor 141, which extend to the outside of the housing through three openings formed at substantial intervals of 120 degrees in a side surface of the housing 148, are bent in the same height as the bottom surface of the housing so that the circulator may be connected and soldered to an electrode on a printed circuit board of a system to which the circulator is to be mounted. As illustrated in FIG. 3, such a surface-mount structure is commercialized and actually used, but has exhibited various technical limitations. The three bent connection leads 141a, 141b and 141c of the center conductor may easily be deformed even with a small external shock during a production process of a product or while mounted on the printed circuit board of the system, and this causes high process failure.

FIG. 4 illustrates a configuration of the non-reciprocal element disclosed in Korean patent No. 10-193637.

The inventions such as Korean patent No. 10-193637, which discloses an invention relating to a non-reciprocal element having the configuration like FIG. 4, have been published as the technology that can solve such limitations. In Korean Patent No. 10-193637, input and output terminals 51, 52 and 53 are formed of pin-like conductors, and are inserted into and fixed to an insulating mechanism 100 made by injection molding. In this case, the insulating mechanism 100 made by injection molding is exposed to the outside through an opening of a housing 600 made of a soft magnetic material, and magnetic and circuit elements which are laminated and inserted in the housing 600 are also fixed by the insulating mechanism 100.

However, the structure disclosed in the Korean Patent No. 10-193637 is a structure in which threads formed by machining inside the housing 600 are engaged and assembled to the threads formed by machining on the outside of a lid 41, so that the manufacturing cost is high and the automation of the assembly is difficult.

Accordingly, various solution methods have been disclosed to solve these limitations.

FIG. 5 illustrates the structure of the non-reciprocal element disclosed in U.S. Pat. No. 6,011,449. The non-reciprocal element disclosed in U.S. Pat. No. 6,011,449 is designed such that recess grooves are formed in a side surface of a housing made by sheet stamping, a plurality of hooks are formed in a lid also made by sheet stamping, and the hooks are hung and fixed to the recess grooves of the housing. Such a design structure has been successfully employed and applied to many circulators, and such a method is adopted in the technique illustrated in FIG. 2. However, in order that the hooks formed in the lid and the recess grooves formed in the housing are engaged with and assembled to each other, a certain degree of free space is required between the outer diameter of the housing and the inner diameter of the lid, and this space enlarges the size of a product manufactured using the structure and therefore makes it difficult to reduce the size of the product. In addition, the hooks formed in the lid require physical sizes of at least certain sizes in terms of the functions thereof, and makes it difficult to reduce the product size.

FIG. 6 is the structure of a non-reciprocal element disclosed in Korean Patent Publication No. 10-2010-0128117. Korean patent Publication No. 10-2010-0128117 discloses a non-reciprocal circuit element including a housing body, laminated components, and a cover. The non-reciprocal circuit element is characterized in that a plurality of hook portions 130a are provided which protrude inward and upward from some points of a side surface outer circumferential portion of the cover, and in order to fasten the cover and the housing body, engaging protrusion parts 124 are provided which protrude on an upper end of a side wall of the housing body toward the outside of the side wall. Such the structure has a limitation in that it is difficult to apply the structure when the size of the non-reciprocal circuit element becomes very small.

### SUMMARY

The present disclosure provides a non-reciprocal element having a structure which has high reliability suitable for mass production, and a method for assembling the same.

In accordance with an exemplary embodiment, a non-reciprocal circuit element including a housing (600) and a lid (41) coupled to the housing may be provided. At this point, a coupling hole (411) is formed in a side rim (460) of the lid, a guide recess (401) recessed upward is formed at a lower edge of the side rim, a coupling protrusion (601) protruding outward is formed in a circumferential side portion (620) of the housing, the coupling protrusion is inserted and coupled to the coupling hole, and the guide recess is disposed below the coupling hole.

The non-reciprocal circuit element may further include a laminate portion (179) laminated on a bottom portion (610) of the housing and comprising a center conductor (200). In addition, the lid may cover the laminate portion.

The lid may include the side rim and an elastic pressing portion (450), the elastic pressing portion may have a shape in which a central section of the elastic pressing portion is bent further downward than a peripheral section of the central section when the lid is not fastened to the housing, and the elastic pressing portion may be configured such that the central section of the elastic pressing portion may come into contact with an upper surface of the laminate portion and be pushed upward when the lid is fastened to the housing.

The non-reciprocal circuit element may be a circulator.

The non-reciprocal circuit element may be an isolator.

A second coupling hole (412) may further be provided at the side rim, a second guide recess (402) recessed upward may further be provided on a lower edge of the side rim, a second coupling protrusion (602) protruding outward may further be provided at the circumferential side portion, the second coupling protrusion may be inserted and coupled to the second coupling hole, and the second guide recess may be disposed below the second coupling hole.

In accordance with another exemplary embodiment, a method for manufacturing the abovementioned non-reciprocal element may be provided. The method may include: inserting a lid into a housing and lowering the lid in a state in which the housing and the lid are separated from each other; rotating the lid with respect to the housing so that a coupling protrusion is engaged with a guide recess and aligned when a lower edge of a side rim of the lid comes into contact with the coupling protrusion; and pressing the lid downward and inserting the coupling protrusion into the coupling hole in a state in which the coupling protrusion is engaged with the guide recess and aligned.

In accordance with yet another exemplary embodiment, a non-reciprocal circuit element including a housing (600) and a lid (41) coupled to the housing may be provided. Here, a coupling hole (411R) is formed at a circumferential side portion (620) of the housing, a guide recess (401R) recessed downward is formed at an upper edge of the circumferential side portion, a coupling protrusion (601R) protruding inward is formed in a side rim (460) of the lid, the coupling protrusion is inserted and coupled to the coupling hole, and the guide recess is disposed above the coupling hole.

In accordance with still another exemplary embodiment, a method for manufacturing the non-reciprocal element may be provided. The method includes: inserting a lid into a housing and lowering the lid in a state in which the housing and the lid are separated from each other; rotating the lid with respect to the housing so that a coupling protrusion is engaged with a guide recess and aligned when an upper edge of a circumferential side portion of a circumferential side portion comes into contact with the coupling protrusion; and pressing the lid downward and inserting the coupling protrusion into the coupling hole in a state in which the coupling protrusion is engaged with the guide recess and aligned.

### BRIEF DESCRIPTION OF THE DRAWINGS

Exemplary embodiments can be understood in more detail from the following description taken in conjunction with the accompanying drawings, in which:

FIG. 1 illustrates a general symbol for a circulator;

FIG. 2 is an exploded assembly view of a general surface mount-type circulator;

FIG. 3 is a side view of a general surface mount-type circulator;

FIG. 4 illustrates a configuration of the non-reciprocal element disclosed in Korean patent No. 10-193637;

FIG. 5 illustrates the structure of the non-reciprocal element disclosed in U.S. Pat. No. 6,011,449;

FIG. 6 is the structure of the non-reciprocal element disclosed in Korean Patent Publication No. 10-2010-0128117;

FIGS. 7A, 7B and 7C illustrate perspective view, a front view, and a bottom view of the non-reciprocal element provided in accordance with an exemplary embodiment;

FIG. 8 illustrates a development view of the non-reciprocal element illustrated in FIGS. 7A-C in accordance with an exemplary embodiment;

FIG. 9 separately illustrates portions of a body and a lid among the non-reciprocal element illustrated in FIGS. 7A-C;

FIGS. 10A and 10B are exemplary vertical cross-sectional views of coupling protrusions formed on a housing of the non-reciprocal element illustrated in FIGS. 7A-7C;

FIG. 11 illustrates the structure of a center conductor illustrated in FIG. 8;

FIGS. 12 and 13 illustrate the structure and the coupling relationship of a housing, a frame, and a conductive pin illustrated in FIG. 8;

FIG. 14 illustrates the structure of the frame illustrated in FIG. 8;

FIGS. 15A, 15B and 15C illustrate the coupling relationship between the frame and a first laminate portion illustrated in FIG. 8;

FIGS. 16A and 16B illustrate the coupling relationship between the conductive pin illustrated in FIG. 8 and a through-hole illustrated in FIG. 14, and a dimensions of the shapes of a support portion and a reinforcing portion in the frame;

FIG. 17 is a perspective view when a state, in which a frame coupled with a conductive pin is inserted and coupled to a housing, is viewed from top to bottom;

FIG. 18 illustrates a cross-sectional view of a non-reciprocal element 1 taken along line A-B of FIG. 14 in a state in which the non-reciprocal element 1 illustrated in FIG. 8 is completed; and

FIG. 19 illustrates a modified exemplary embodiment from FIG. 9.

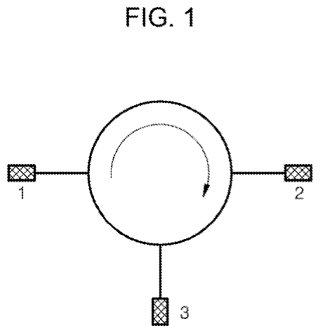

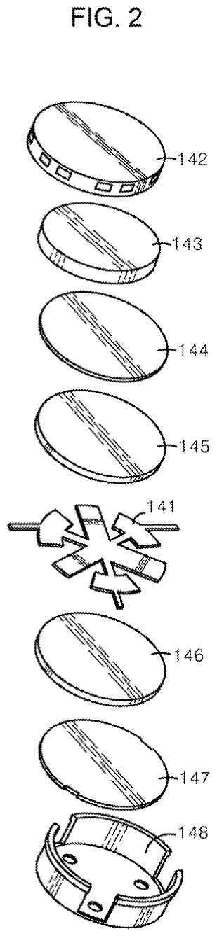

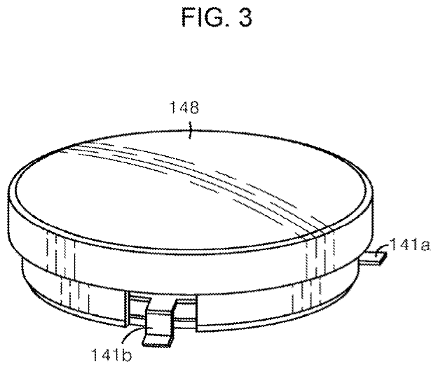

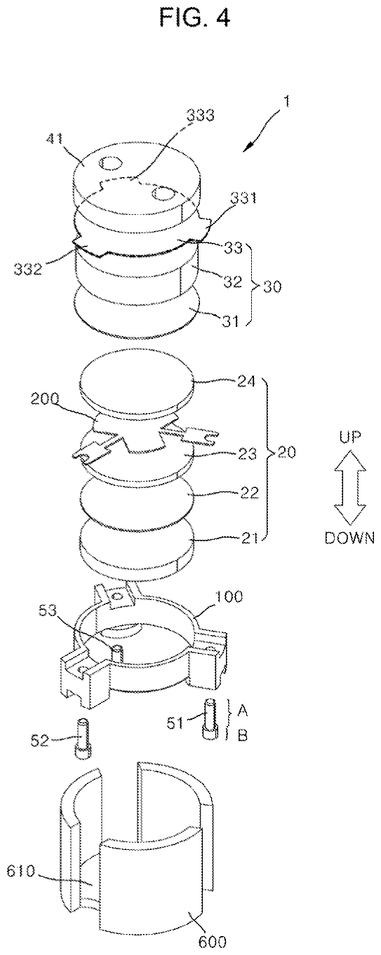

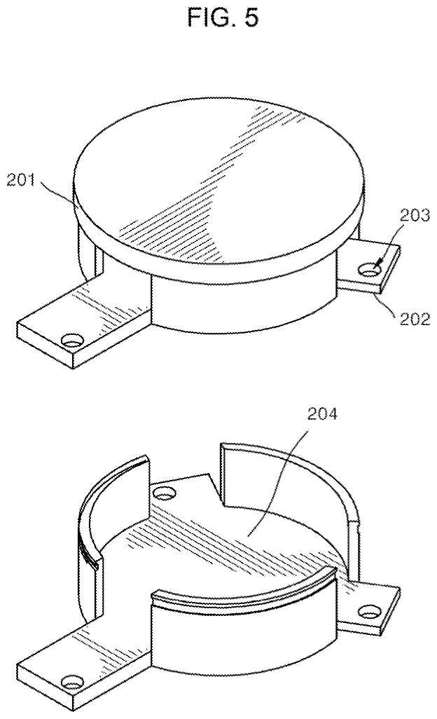

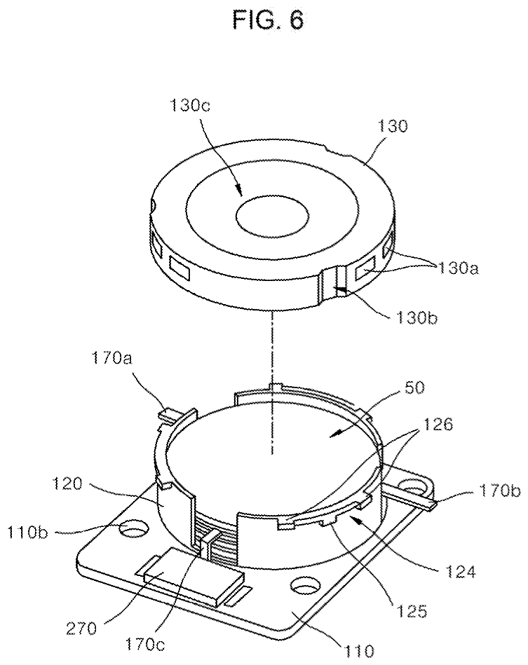

### DETAILED DESCRIPTION OF EMBODIMENTS

The structural and functional descriptions specified with regard to exemplary embodiments disclosed in the specification or the application are merely illustrated to explain the exemplary embodiments. The exemplary embodiments may be implemented in various forms and should not be construed as being limited in the exemplary embodiments described in the specification or the application.

The exemplary embodiments may be variously modified and have various forms, and thus, specific exemplary embodiments will be illustrated in the drawings and described in detail in the specification or the application. However, this does not limit the present disclosure within specific embodiments and it should be understood that the present disclosure covers all the modifications, equivalents, and replacements within the idea and technical scope of the inventive concept.

It will be understood that although the terms of first and second are used herein to describe various elements, these elements should not be limited by these terms. The terms are used to discriminate one component from other components, and for example, a first component may be referred to as a second component without departing from the spirit and scope of the present disclosure, and similarly, the second component may also be referred to as the first component.

In the description, the technical terms are used only for explaining a specific exemplary embodiment while not limiting the present disclosure. The terms of a singular form may include plural forms unless referred to the contrary. The meaning of ‘include’ or ‘have’ specifies a feature, a number, a step, an operation, an element, a component, or a combination thereof, but should not be construed as excluding in advance the presence or the possibility of adding other features, numbers, steps, operations, elements, components, combinations thereof.

Unless terms used in the present disclosure are defined differently, the terms including technological or scientific terms may be construed to be the same as meaning generally known to those skilled in the art. Terms such as terms that are generally used and have been in dictionaries should be construed as having meanings matched with contextual meanings in the art. In this description, unless defined clearly, terms are not ideally, excessively construed as formal meanings.

Hereinafter, exemplary embodiments of the inventive concept will be described in detail with reference to the accompanying drawings. Like reference numerals refer to like elements throughout.

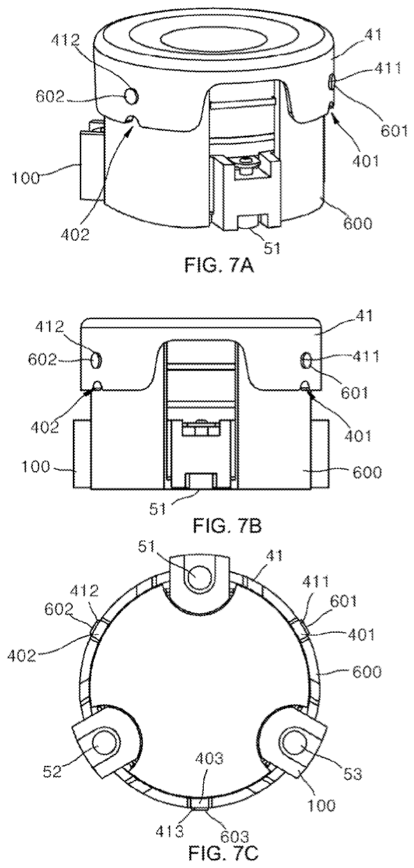

FIGS. 7A-7C illustrate perspective views, a front view, and a bottom view of the non-reciprocal element provided in accordance with an exemplary embodiment.

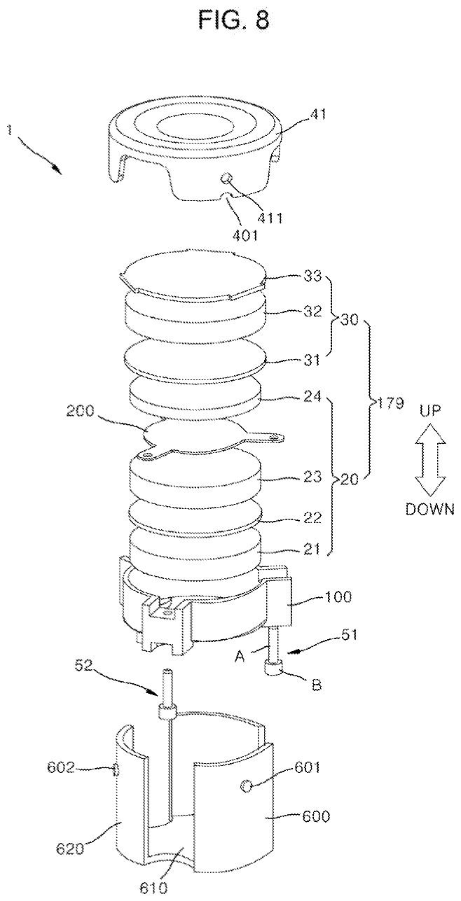

FIG. 8 illustrates a development view of the non-reciprocal element illustrated in FIGS. 7A-C in accordance with an exemplary embodiment.

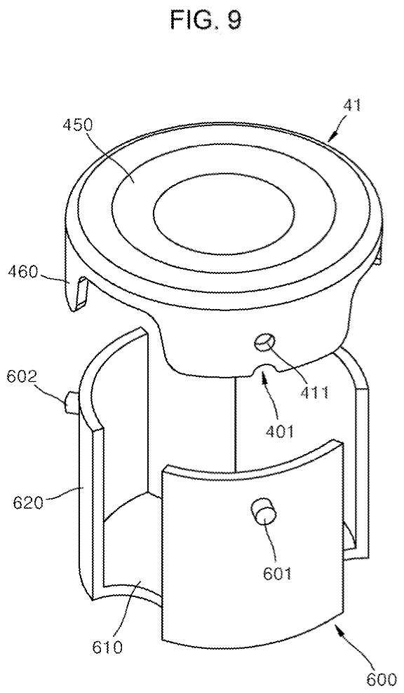

FIG. 9 separately illustrates portions of a body and a lid among the non-reciprocal element illustrated in FIGS. 7A-7C.

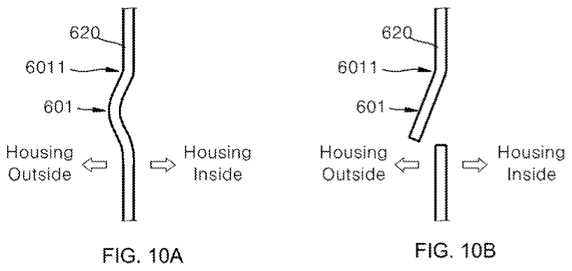

FIGS. 10A-B are exemplary vertical cross-sectional views of coupling protrusions formed on a housing of the non-reciprocal element illustrated in FIGS. 7A-7C.

Hereinafter, descriptions will be provided with reference to FIGS. 7A-C, 8, 9 and 10 together.

The non-reciprocal element 1 may be a passive microwave device.

Hereinafter, for convenience of description, as illustrated in FIG. 8 by arrows, an upward direction and a downward direction are defined.

The non-reciprocal element 1 according to an exemplary embodiment may be, for example, a passive ferrite isolator, a passive ferrite circulator, an isolator, or a circulator.

The non-reciprocal element 1 may include a housing 600.

From an inner wall of the bottom portion 610 of the housing 600, a lower permanent magnet 21, a lower pole piece 22, a lower microwave ferrite 23, a center conductor 200, an upper microwave ferrite 24, an upper pole piece 31, an upper permanent magnet 32, a stopper 33, and a lid 41 may be laminated sequentially.

In this specification, the lower permanent magnet 21, the lower pole piece 22, the lower microwave ferrite 23, the center conductor 200, the upper microwave ferrite 24, the upper pole piece 31, the upper permanent magnet 32, and the stopper 33 may be totally referred to as internal elements. Each of the internal elements may have a disk shape or a shape modified from the disk shape. The thickness of each internal element may be the same or mutually different.

In an exemplary embodiment, a laminate structure formed by the lower permanent magnet 21, the lower pole piece 22, the lower microwave ferrite 23, the center conductor 200, and the upper microwave ferrite 24 may be referred to as a first laminate portion 20. In addition, in the present disclosure, a laminate structure formed by the upper pole piece 31, the upper permanent magnet 32, and the stopper 33 may be referred to as a second laminate portion 30.

A laminate structure in which the first laminate portion 20 and the second laminate portion 30 are coupled to each other may be referred to as a laminate portion 179. Alternatively, a structure formed by laminating the internal elements with respect to each other may be referred to as the laminate portion 179.

The lid 41 may include an elastic pressing portion 450 and a side rim 460 which has a shape bent and extending downward along the edge of the elastic pressing portion 450. One coupling hole 411 or a plurality of coupling holes 411, 412 and 413 may be formed in a circumferential side portion of the lid 41.

The elastic pressing portion 450 may have a shape in which the center portion of the elastic pressing portion 450 is bent slightly to a lower side than the peripheral portion thereof when the lid 41 is not fastened to the housing 600. In addition, the elastic pressing portion 450 is configured to be in contact with the stopper 33, that is, an upper surface of the laminate portion 179 and be pushed upward when the lid 41 is fastened to the housing 600, and consequently, the laminate coupled body of the internal elements may be pressed downward by the elastic pressing portion 450. The elastic pressing portion 450 may be formed in, for example, a shape of a plate spring.

The housing 600 may include a bottom portion 610 and a circumferential side portion 620 having a shape bent and extending along the edge of the bottom portion 610. One coupling protrusion 601 or a plurality of coupling protrusions (bumps) 601, 602 and 603 may be formed which protrude toward the one coupling hole 411 or the plurality of coupling holes 411, 412 and 413.

The plurality of coupling protrusions 601, 602, and 603 are respectively formed at the positions corresponding to the plurality of coupling holes 411, 412 and 413, and the plurality of coupling protrusions 601, 602 and 603 may be fitted and coupled to the plurality of coupling holes 411, 412 and 413.

The plurality of coupling protrusions 601, 602 and 603 may each be formed by punching in a direction from the inside of the circumferential side portion 620 of the housing 600 to the outside and bending the circumferential side portion 620. Consequently, as illustrated in (a) of FIG. 10, each of the plurality of coupling protrusions 601, 602 and 603 may be a portion having a shape in which the circumferential side portion 620 protrudes outward from the housing 600. At this point, as illustrated in (b) of FIG. 10, lower edge portions of the coupling protrusions 601, 602 and 603 may also be in a state of being torn and separated from the circumferential side portion 620.

A plurality of guide recesses 401, 402 and 403 are formed directly below the plurality of coupling protrusions 411, 412 and 413 in the lower edge of the side rim 460 of the lid 41. Each of the guide recesses may be a portion in which the lower edge of the side rim 460 has a shape recessed upward from a lower side.

The plurality of guide recesses 401, 402 and 403 are provided to assist the process of coupling the lid 41 to the housing 600. That is, in order that the plurality of coupling protrusions 601, 602, and 603 are respectively coupled to the plurality of coupling holes 411, 412 and 413, the plurality of coupling protrusions 601, 602 and 603 should be aligned with respect to the plurality of coupling holes 411, 412 and 413. At this point, when the lid 41 is moved downward in order to couple the lid 41 to the housing 600, the plurality of coupling protrusions 601, 602, and 603 come into contact with the lower edge of the side rim 460 of the lid 41. In such contact state, when the lid 41 is rotated clockwise or counterclockwise while pressing the lid 41, the plurality of coupling protrusions 601, 602, and 603 enter the inside of the plurality of guide recesses 401, 402 and 403 at a certain moment. This state is the state in which the plurality of coupling protrusions 601, 602, and 603 are aligned with respect to the plurality of coupling holes 411, 412 and 413. In such the aligned state, when a force is applied to the lid 41 only in a downward direction without rotating the lid 41, the plurality of coupling protrusions 601, 602, and 603 are coupled to the plurality of coupling holes 411, 412 and 413.

While the lid 41 is coupled to the housing 600, an upper bent portion 6011 of the plurality of coupling protrusions 601, 602, and 603 may be processed so as to have a shape which is not abruptly bent, but gradually bent in a downward direction so that the lower edge portion of the side rim 460 of the lid 41 may extend over the plurality of coupling protrusions 601, 602, and 603.

While the lid 41 is coupled to the housing 600, the side rim 460 of the lid 41 may be formed of an elastic material so that the side rim 460 of the lid 41 may be temporarily bent outward and restored. Alternatively, while the lid 41 is coupled to the housing 600, the circumferential side portion 620 of the housing 600 may be formed of an elastic material so that the circumferential side portion 620 of the housing 600 may be temporarily bent outward and restored.

N number of the plurality of coupling protrusions 601, 602, and 603, the plurality of guide recesses 401, 402 and 403, and the plurality of coupling holes 411, 412 and 413 may each be provided. In a preferred exemplary embodiment, N may be 2 or 3, but in a modified exemplary embodiment, N may assume various natural numbers such as 1, 4, 5 or 6.

The frame 100 may be disposed between the inner wall of the circumferential side portion 620 of the housing 600 and an outer edge of the first laminate portion 20. The first laminate portion 20, the second laminate portion 30, and the frame 100 may all be arranged to be accommodated in the circumferential side portion 620 of the housing 600 on the bottom portion 610 of the housing 600. At this point, a portion of the frame 100 and a portion of the center conductor 200 may protrude and be exposed to the outside of the circumferential side portion of the housing 600. In the present disclosure, the frame 100 may also be referred to as an aligning frame.

Three conductive pins 51, 52, and 53 may be coupled to the frame 100. Each of the conductive pins 51, 52 and 53 may be formed of a penetration portion A and a head portion B.

The housing 600 may be formed of a conductive soft magnetic material, and the lid 41 may be a soft magnetic material.

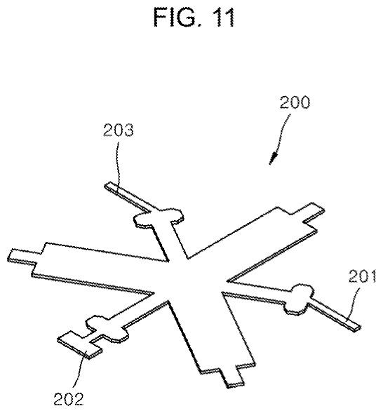

FIG. 11 illustrates a structure r of a center conductor illustrated in FIG. 8.

The center conductor 200 may include a plurality of connection leads 201, 202 and 203 substantially having intervals of 120 degrees.

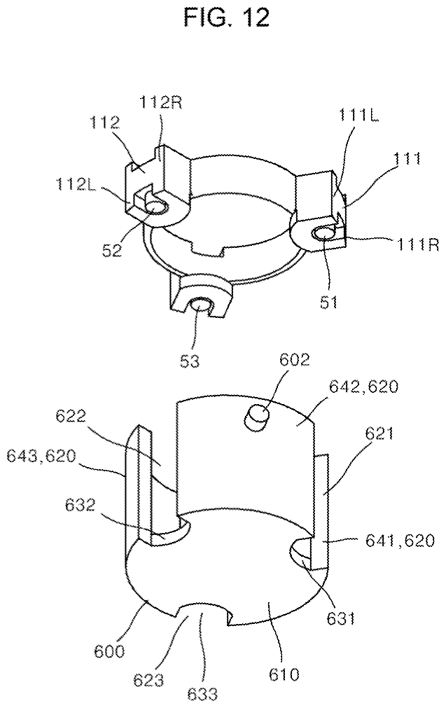

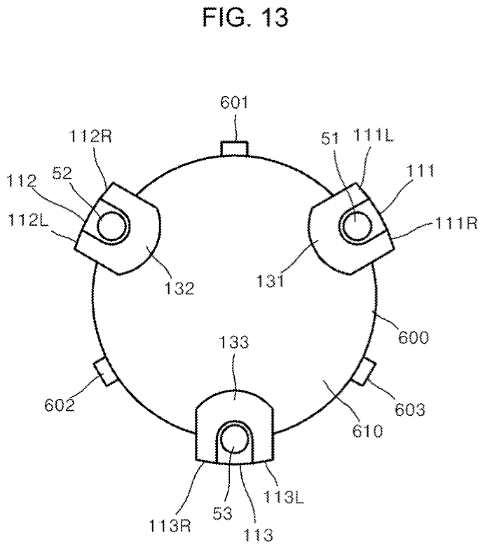

FIGS. 12 and 13 illustrate the structure and the coupling relationship of the housing, the frame, and the conductive pins illustrated in FIG. 8.

FIG. 12 is a perspective view seen from a lower side surface with respect to FIG. 8.

FIG. 13 is a bottom view seen from bottom to top with respect to FIG. 8 in a state in which the housing, the frame, and the conductive pins are coupled to each other.

The housing 600 has a shape in which a top portion and other specific portions are removed from a cylindrical structure. The other removed specific portions are indicated by reference numerals 621, 622, 623, 631, 632, and 633 in FIG. 12.

In an exemplary embodiment, a top portion may not be present in the housing 600. The housing 600 may have a shape modified from a cylindrical structure in which the circumferential side portion 620 and the bottom portion 610 are present. The housing 600 may include: a plurality of circumferential side portions 620 (641, 642 and 643); a plurality of openings 621, 622, and 623 selectively positioned inside the circumferential side portions 641, 642, 643; and a flat bottom portion 610 connected to the lower boundary lines of the circumferential side portions 620 (641, 642 and 643).

In an exemplary embodiment, the numbers of the circumferential side portions and the openings may be the same as the number of the connection leads of the center conductor 200. For example, the number may be three.

The bottom portion 610 may have a disk-like overall shape. At this point, a plurality of notch portions 631, 632, and 633 recessed toward the center portion of the bottom portion 610 may be formed in the edge of the bottom portion 610. Unless the notch portions 631, 632, and 633 are not formed in the bottom portion 610, the bottom portion may have a disk shape.

An arbitrary notch portion of the notch portions may be formed at a position corresponding to any one of the openings.

Three conductive pins 51, 52, and 53 may be inserted and coupled to the frame 100.

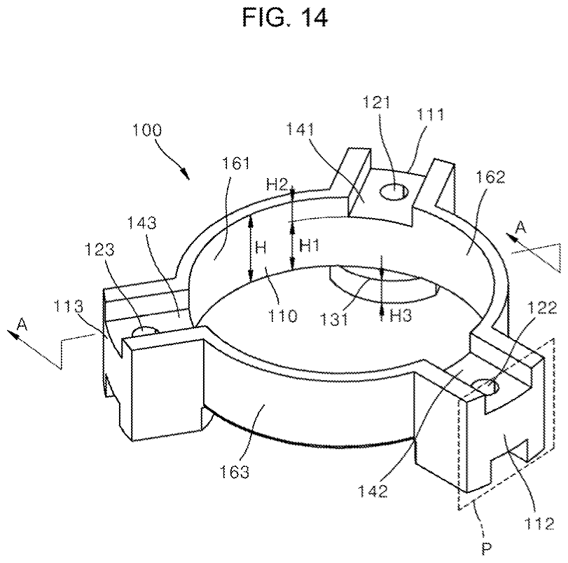

FIG. 14 illustrates the structure of the frame illustrated in FIG. 8.

The frame 100 may be made of a non-conductive material. The frame 100 may be made of a resin material.

The frame 100 may include:

1) a ring shaped body 110;

2) a plurality of fence portions 161, 162 and 163 which extend upward in an upstanding manner from a lower edge of the body 110 and are separated from each other by a plurality of accommodation spaces 141, 142 and 143 arranged to accommodate the connection leads 201, 202 and 203 of the center conductor 200;

3) a plurality of support portions 111, 112 and 113 extending outward in a radial direction from the region of the plurality of accommodation spaces 141, 142 and 143 in order to support the connection leads 201, 202 and 203 of the centre conductor 200;

4) a plurality of through-holes 121, 122 and 123 formed to pass through the plurality of respective support portions 111, 112 and 113;

5) a plurality of leg portions 131, 132 and 133 which extend downward and radially inward from the lower edge of the body 110 and protrude; and

6) reinforcing portions 111L, 111R, 112L, 112R, 113L, and 113R extending vertically from the left edge and the right edge of the respective support portions 111, 112 and 113.

All components of the frame 100 may be manufactured in an integrated shape.

In FIG. 14, the boundary portions of the body 110 and the fence portions 161, 162 and 163 are depicted by dotted lines. In the boundary portion of the body 110 and the fence portions 161, 162 and 163, a step may not be present.

For convenience of description in this specification, the height H of the frame 100 may be defined as the sum of the height H1 of the body 110 and the height H2 of the fence portions 161, 162 and 163, and at this point, the height of the frame 100 may not include the height H3 of the leg portions 131, 132 and 133.

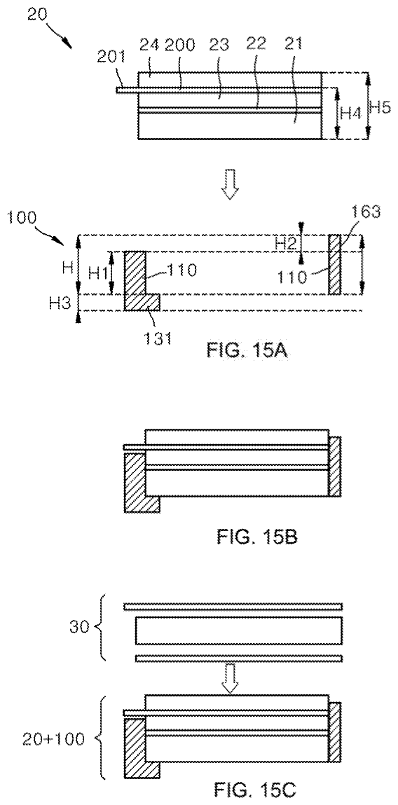

FIGS. 15A-C illustrate the coupling relationship between the frame and a first laminate portion illustrated in FIG. 8.

(a) of FIG. 15 illustrates in detail each portion of the frame 100 and the first laminate portion 20, (b) of FIG. 15 illustrates a state in which the frame 100 and the first laminate portion 20 are coupled, and (c) of FIG. 15 illustrates a process in which the second laminate portion 30 is coupled while the first laminate portion 20 is coupled to the frame 100.

The frame 100 shown in (a) and (b) of FIG. 15 illustrates a cross-sectional view taken in a vertical direction along line A-B in the exemplary embodiment illustrated in FIG. 14.

The height H of the frame 100 may be smaller than the height H5 of the first laminate portion 20. That is, the sum of the height H1 of the body 110 and the height H2 of the fence portions 161, 162 and 163 may be smaller than the sum of the entire height (thickness) H5 of the first laminate portion 20. That is, the height H of the frame 100 may be smaller than the sum H5 of the heights of the lower permanent magnet 21, the lower pole piece 22, the lower microwave ferrite 23, the center conductor 200 and the upper microwave ferrite 24. However, at this point, the height H of the frame 100 may be larger than the sum H4 of the heights of the lower permanent magnet 21, the lower pole piece 22, the lower microwave ferrite 23, and the center conductor 200.

Due to such a structure, the centers of gravity of the internal elements included in the first laminate portion 20 may be aligned to each other. In addition, the lower portion of the microwave ferrite 24 may be closed inside the frame 100, and the upper portion thereof may protrude upward from the upper edge of the frame 100 and be exposed. Accordingly, when the second laminate portion 30 is assembled onto the first laminate portion 20, the second laminate portion 30 may press the first laminate portion 20 without being interfered by the frame 10.

Referring again to FIGS. 14 and 15, the inside surface of the body 110 and the inside surfaces of the fence portions 161, 162 and 163 may substantially correspond to a portion of the inside surface of a virtual cylinder. The internal elements included in the first laminate portion 20 may be accommodated in the inside surface of the body 110 and the inside surfaces of the fence portions 161, 162 and 163.

The frame 100 may provide a function such that an outer radial peripheral section of the first laminate portion 20 and the inner wall of the housing 600 maintain a gap larger than 0 therebetween, and the first laminate portion 20 is electrically insulated from the housing 600. That is, the frame 100 may provide a function such that an outer radial peripheral section of the lower permanent magnet 21, the lower pole piece 22, the lower microwave ferrite 23, the center conductor 200 and the upper microwave ferrite 24 and the inner wall of the housing 600 maintain a gap larger than 0 therebetween. To this end, the frame 100 may be made of a non-conductive material.

In addition, the frame 100 may provide a function of aligning the internal elements constituting the first laminate portion 20 with respect to each other. That is, the frame 100 may provide a function of aligning the lower permanent magnet 21, the lower pole piece 22, the lower microwave ferrite 23, the center conductor 200 and the upper microwave ferrite 24 with respect to each other.

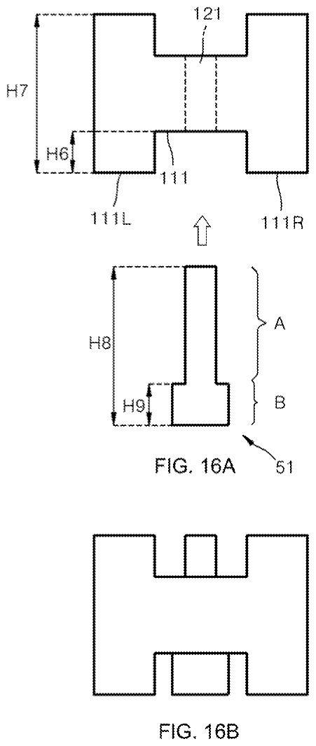

FIGS. 16A and 16B illustrate the coupling relationship between the conductive pin illustrated in FIG. 8 and the through-hole illustrated in FIG. 14, and dimensions of the shapes of a support portion and a reinforcing portion in the frame.

For convenience of description, FIGS. 16A and 16B only illustrates: a through-hole 121 among the plurality of rough-holes 121, 122 and 123, a conductive pin 51 among a plurality of conductive pins 51, 52 and 53, reinforcing portions 111L and 111R among a plurality of reinforcing portions 111L, 111R, 112L, 112R, 113L, and 113R, and a support portion 111 among a plurality of support portions 111, 112 and 113.

The drawing on the upper side of (a) of FIG. 16 illustrates the portion P illustrated in FIG. 14 when viewed from an outside viewpoint with respect to FIG. 8. At this point, it may be found that the portion P has a shape of an “H” beam.

(b) of FIG. 16 illustrates a state in which the conductive pin 51 illustrated in (a) of FIG. 16 is coupled to the through-hole 121.

The plurality of conductive pins 51, 52 and 53 may pass through and coupled to the plurality of respective through-holes 121, 122 and 123. Each of the conductive pins 51, 52 and 53 may be formed of a penetration portion A and a head portion B. A horizontal cross-section of the penetration portion A may have a shape fittable into each of the through-holes 121, 122 and 123, and a horizontal cross-section of the head portion B may have a shape such that the head portion B may not pass through each of the through-holes 121, 122 and 123 when the penetration portion A passes through each of the through-holes 121, 122 and 123. In an exemplary embodiment, the horizontal cross-section of the head portion B and the horizontal cross-section of the penetration portion A may both have circular shapes, and the horizontal surface of the head portion B may be wider than the horizontal cross-section of the penetration portion A.

The conductive pins 51, 52 and 53 may be fitted and coupled to the through-holes 121, 122 and 123 from top to bottom or may also be fitted and coupled from bottom to top. FIG. 8 illustrates an example of coupling from bottom to top, but the embodiments of the present disclosure are not limited thereto.

The length H8 of each of the conductive pins 51, 52 and 53 may substantially be the same as the vertical length H7 of each of the reinforcing portions 111L, 111R, 112L, 112R, 113L, and 113R.

For example, while inserting the conductive pin 51 into the through-hole 121, when the head portion B is hung to the support portion 111, both end sections of the conductive pin 51 may be aligned to upper and lower end sections of the reinforcing portions 111L and 111R in this state. To this end, the gap H6 between the lower surfaces of the reinforcing portions 111L and 111R and the lower surface of the support portion 111 may be the same as the vertical width H9 of the head portion B.

The connection leads 201, 202 and 203 of the center conductor 200 are arranged on the upper surfaces of the plurality of support portions 111, 112 and 113, and the connection leads 201, 202 and 203 may each be electrically/physically coupled to the upper end sections of the corresponding conductive pins 51, 52 and 53. Such coupling may be performed by heating and pressing and may also be performed through a method such as soldering.

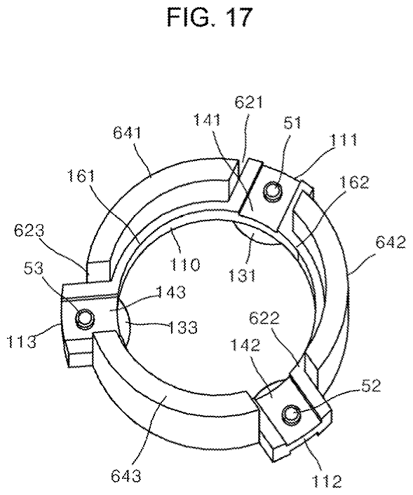

FIG. 17 is a perspective view when a state, in which a frame coupled with a conductive pin is inserted and coupled to a housing, is viewed from top to bottom.

The frame 100 may be inserted and coupled to the housing 600. Specifically, a plurality of leg portions 131, 132 and 133 formed in the frame 100 are inserted and coupled into the plurality of notch portions 631, 632 and 633 formed in the housing 600, whereby the frame 100 may be coupled to the housing 600. To this end, each of the leg portions 131, 132 and 133 may have a shape corresponding to the shape of each of the notch portions 631, 632 and 633. In order to enable the inserting and coupling, the housing 600 may be made of a hard metal and the frame 100 may be made of a synthetic resin.

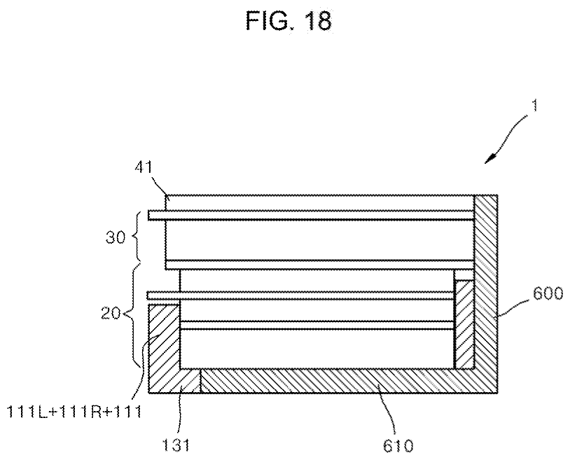

FIG. 18 illustrates a cross-sectional view of a non-reciprocal element 1 taken along line A-B of FIG. 14 in a state in which the non-reciprocal element 1 illustrated in FIG. 8 is completed.

In a state in which the frame 100 is inserted and coupled to the housing 600, and the conductive pins 51, 52 and 53 are inserted and coupled to the respective through-holes, 1) the lower surface of the bottom portion 610 of the housing 600, 2) the lower surfaces of the respective leg portions 131, 132 and 133, 3) the lower end sections of the respective reinforcing portions 111L, 111R, 112L, 112R, 113L and 113R, and 4) the lower end sections of the respective conductive pins 51, 52 and 53 may be configured to be positioned on the same first plane. The above components may each have an appropriate dimension for this.

The vertical width of each of the leg portions 131, 132 and 133 may be the same as the thickness of the bottom portion 610 of the housing 600. Accordingly, in a state in which the frame 100 is inserted and coupled to the housing 600, 1) the upper surface of the bottom portion 610 of the housing 600, and 2) the upper surface of the each of the leg portions 131, 132 and 133 may both be positioned on the same second plane

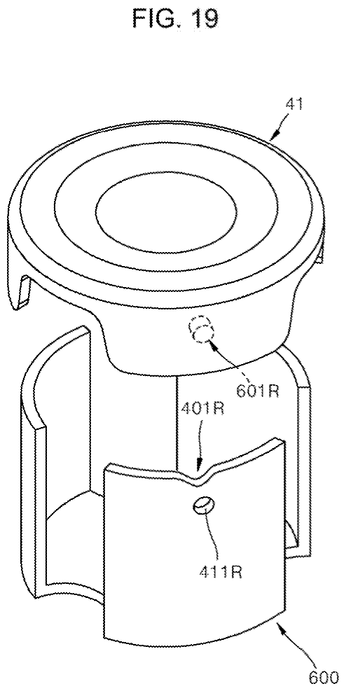

FIG. 19 illustrates an exemplary embodiment modified from FIG. 9.

A plurality of coupling holes 411R, 412R, and 413R corresponding to the plurality of coupling holes 411, 412 and 413 illustrated in FIG. 9 are formed in a circumferential side portion 620 of a housing 600.

A plurality of coupling protrusions 601R, 602R and 603R corresponding to the plurality of coupling protrusions 601, 602 and 603 illustrated in FIG. 9 protrude inward from a circumferential side portion 450 of a lid 41.

A plurality of guide recesses 401R, 402R, and 403R corresponding to the plurality of guide recesses 401, 402 and 403 illustrated in FIG. 9 are formed in an upper edge portion of the circumferential side portion 620 of a housing 600.

It may easily be understood that the mutual coupling principle of the housing and the lid illustrated in FIG. 19 is the same as the mutual coupling principle of the housing and the lid illustrated in FIG. 9.

In accordance with the present disclosure, a non-reciprocal element having a structure which has high reliability suitable for mass production and a method for assembling the same may be provided.

So far, the present disclosure has been described with reference to exemplary embodiments shown in the drawings, but this is merely an exemplary example, and those skilled in the art would understand that various modification and equivalent other embodiments can be made therefrom. Hence, the real protective scope of the present invention should be determined by the technical scope of the accompanying claims.

What is claimed is:

1. A non-reciprocal circuit element comprising:
a housing (600); and
a lid (41) coupled to the housing,
wherein,
a coupling hole (411) is formed at a side rim (460) of the lid,
a guide recess (401) recessed upward is formed at a lower edge of the side rim,
a coupling protrusion (601) protruding outward is formed at a circumferential side portion (620) of the housing,
the coupling protrusion is inserted and coupled to the coupling hole, and
the guide recess is disposed below the coupling hole.

2. The non-reciprocal circuit element of claim 1, further comprising a laminate portion (179) laminated on a bottom portion (610) of the housing and comprising a center conductor (200),
wherein, the lid covers the laminate portion.

3. The non-reciprocal circuit element of claim 2, wherein
the lid comprises the side rim and an elastic pressing portion (450),
the elastic pressing portion has a shape in which a central section of the elastic pressing portion is bent further downward than a peripheral section of the central section when the lid is not fastened to the housing, and
the elastic pressing portion is configured such that the central section of the elastic pressing portion comes into contact with an upper surface of the laminate portion and is pushed upward when the lid is fastened to the housing.

4. The non-reciprocal circuit element of claim 1, wherein the non-reciprocal circuit element is a circulator.

5. The non-reciprocal circuit element of claim 1, wherein the non-reciprocal circuit element is an isolator.

6. The non-reciprocal circuit element of claim 1, wherein
a second coupling hole (412) is further provided at the side rim,
a second guide recess (402) recessed upward is further provided at a lower edge of the side rim,
a second coupling protrusion (602) protruding outward is further provided at the circumferential side portion,
the second coupling protrusion is inserted and coupled to the second coupling holes, and
the second guide recess is disposed below the second coupling holes.

7. A method for manufacturing the non-reciprocal circuit element of claim 1, the method comprising:
inserting a lid into a housing and lowering the lid in a state in which the housing and the lid are separated from each other;
rotating the lid with respect to the housing so that the coupling protrusion is engaged with the guide recess and aligned when a lower edge of a side rim of the lid comes into contact with the coupling protrusion; and
pressing the lid downward and inserting the coupling protrusion into the coupling hole in a state in which the coupling protrusion is engaged with the guide recess and aligned.

8. A non-reciprocal circuit element comprising:
a housing (600); and
a lid (41) coupled to the housing,
wherein,
a coupling hole (411R) is formed at a circumferential side portion (620) of the housing,
a guide recess (401R) recessed downward is formed at an upper edge of the circumferential side portion,
a coupling protrusion (601R) protruding inward is formed at a side rim (460) of the lid,
the coupling protrusion is inserted and coupled to the coupling hole, and
the guide recess is disposed above the coupling hole.

9. A method for manufacturing the non-reciprocal circuit element of claim 8, the method comprising:
inserting a lid into a housing and lowering the lid in a state in which the housing and the lid are separated from each other;
rotating the lid with respect to the housing so that the coupling protrusion is engaged with the guide recess and aligned when an upper edge of a circumferential side portion of a circumferential side portion comes into contact with the coupling protrusion; and
pressing the lid downward and inserting the coupling protrusion into the coupling hole in a state in which the coupling protrusion is engaged with the guide recess and aligned.
